(19) United States
(12) Patent Application Publication
(10) Pub. No.: US 2011/0081276 A1
(43) Pub. Date: Apr. 7, 2011

(54) PARTICULATE SENSING ELEMENT AND PARTICULATE SENSOR HAVING THE PARTICULATE SENSING ELEMENT

(75) Inventors: Shinya Teranishi, Chita-gun (JP); Hiroshi Matsuoka, Kariya-shi (JP); Keigo Mizutani, Okazaki-shi (JP); Takashi Sawada, Chiryu-shi (JP); Hideaki Itoh, Kuwana-shi (JP); Takashi Araki, Nagoya (JP); Kensuke Takizawa, Nishio-shi (JP)

(73) Assignee: DENSO CORPORATION, Kariya-city (JP)

(21) Appl. No.: 12/898,231

(22) Filed: Oct. 5, 2010

(30) Foreign Application Priority Data
Oct. 5, 2009 (JP) 2009-231188

(51) Int. Cl. G01N 27/00

(52) U.S. Cl. 422/83

(57) ABSTRACT

A particulate sensing element that detects a concentration of electrically conductive particulates PM in a gas to be measured includes a sensing portion exposed to the gas to be measured in which a pair of sensing electrodes that face each other formed with a predetermined gap therebetween on a surface of an electrically insulating heat resistant base plate, and a heating element that heats the sensing portion to a predetermined temperature, wherein a catalyst layer that can oxidize the electrically conductive particulates PM is formed at least on a part of a portion except the sensing portion exposed to the gas to be measured.

### CROSS-REFERENCE TO RELATED APPLICATION

This application is based on and claims the benefit of priority from earlier Japanese Patent Application No. 2009-231188 filed Oct. 5, 2009, the description of which is incorporated herein by reference.

### BACKGROUND

1. Technical Field

The present embodiment relates to a particulate sensing element which is suitable for sensing the concentration of electrically conductive particulates contained in a gas to be measured, and which is used such as for an exhaust system of an internal combustion engine for a motor vehicle, and to a particulate sensor having the particulate sensing element.

2. Description of the Related Art

In recent years, several attempts have been made to reduce environmentally harmful materials, which are contained in exhaust gases emitted such as from diesel engines or lean-burn gasoline engines, the materials including nitrogen oxides (NOx), particulate materials (PMs), such as carbon, and unburnt hydrocarbon (HC).

The attempts of reducing these materials have been made by providing a combined system which is a combination of a common-rail fuel injection system, a supercharger system, an oxidation catalyst, a diesel particulate filter (DPF), a selective catalytic reduction (SCR) system, an exhaust gas recirculation (EGR) system, and the like.

DPFs used in such a combined system in general have good heat resistance and have a honeycomb structure made of a porous ceramics material with many pores. In such a DPF, PMs are captured and deposited in the pores residing in the porous partition walls of the honeycomb structure.

The PMs captured and deposited in the pores may cause clogging and raise pressure loss. In such a case, the DPF is heated by such as a burner or a heater, or alternatively, a high-temperature exhaust gas is introduced into the DPF such as by post injection that is an injection of a small amount of fuel after an explosive combustion of an engine. In this way, it has been ensured that the PMs captured by the DPF are burnt and removed to thereby reactivate the DPF.

In order to further improve the combustion efficiency of an internal combustion engine, such devices as an onboard diagnostics (OBD) system and sensing means have been required. The onboard diagnostics system plays a role of determining the timing of reactivation of such a DPF, or detecting deterioration, damage, or the like of the DPF.

The sensing means plays a role of highly accurately and continuously detecting the concentration of PMs in an exhaust gas, under feedback control, for example, of an internal combustion engine.

As the sensing means for sensing the concentration of PMs in an exhaust gas, Japanese Patent Application Laid-Open Publication No. 59-197847 discloses a smoke concentration sensor. In the smoke concentration sensor disclosed in this reference, a pair of electrodes is formed on the surface of a base plate having heat resistance and electrical insulation properties.

The portion in between the electrodes is permitted to serve as a sensing portion, while a heating element is formed on the rear face and/or in the inside of the base plate.

Electrically conductive portions on the base plate, excepting the electrodes forming the sensing portion, the sensing portion and the terminal portions, are coated with protective films made of an airtight and electrically insulating material.

The heating element in the vicinity of the boundary between the sensing portion and the protective film is permitted to have a heating density higher than that of the sensing portion. Under these conditions, the sensing portion is heated up to a temperature between 400 degrees Celsius and 600 degrees Celsius inclusive.

In such a smoke concentration sensor, the smoke deposited in the sensing portion and in the vicinity of the boundary of high heating density between the sensing portion and the protective film is heated and removed by the heating element. Accordingly, it is expected that deposition of smoke in these portions is suppressed.

However, those portions which are distanced from the vicinity of the boundary of high heating density between the sensing portion and the protective film will not be heated by the heating element, and accordingly, the surface temperature will be lowered.

Thus, it has been found that a large temperature gradient is formed between the vicinity of the boundary of high surface temperature with high heating density and those portions of low surface temperature, and that, resultantly, the particulates contained in the gas to be measured drifting thereabout are permitted to flow toward the protective film of low temperature due to the temperature gradient and tend to be deposited on the surface of the protective film.

When such a conventional smoke concentration sensor is used over a long period of time, it is likely that the smoke that cannot be heated and removed continues depositing in an area that cannot be heated by the heating element.

Further, the smoke deposited in such an area that cannot be heated may fall out of the area due to external vibration and may cover the sensing portion.

In addition, the smoke deposited in such an area may remain in a cover provided for protecting the sensor and block a port provided at the cover for introducing a gas to be measured. As a result, sensing accuracy of the sensor may be deteriorated.

Furthermore, in generally used conventional smoke concentration sensors, the smoke deposited in a sensing portion is heated by a heating element, or the temperature of a gas to be measured is raised to periodically burn and remove the smoke, for reactivation of the sensor.

However, the temperature that can spontaneously burn PMs is 650 degrees Celsius or more. If the heating temperature is low, PMs may not be sufficiently burnt and removed. In addition, since the time required for burning and removing PMs is long, the electrically insulating and heat resistant base plate may be broken due to the thermal stress repeatedly imposed on the sensing portion at the time of reactivation.

Further, the repeatedly imposed thermal stress may cause migration, for example, by which electrically conductive components of the electrode portions are diffused to thereby deteriorate the durability of the sensor.

### SUMMARY

In light of the situation set forth above, an embodiment provides a particulate sensing element of a simple configuration, for sensing the concentration of electrically conductive particulates contained in a gas to be measured, which sensing element enables low-temperature removal of particulate materials (PMs) attached to a non-heated area that is not heated by a heating element that heats a measuring (sensing) portion, and improves durability and reliability of the sensing element by reducing heating temperature or heating time at the time of reactivating the sensing element, and to provide a particulate sensor having the particulate sensing element.

In a particulate sensing element according to a first aspect of the embodiment, the particulate sensing element that detects a concentration of electrically conductive particulates in a gas to be measured has a sensing portion exposed to the gas to be measured in which a pair of sensing electrodes that face each other formed with a predetermined gap therebetween on a surface of an electrically insulating heat resistant base plate, and a heating element that heats the sensing portion to a predetermined temperature.

A catalyst layer that can oxidize the electrically conductive particulates is formed at least on a part of a portion except the sensing portion exposed to the gas to be measured.

Accordingly, the oxidation inducing activity of the catalyst layer can oxidize and remove the electrically conductive particulates at a temperature lower than 650 degrees Celsius, i.e. the spontaneous burning temperature of the electrically conductive particulates. Thus, the thermal stress imposed on the particulate sensing element can be mitigated to thereby realize the particulate sensing element having high durability.

The particulate sensing element according to a second aspect of the embodiment, the catalyst layer is a first catalyst layer made of a catalyst material that can oxidize electrically conductive particulates at a temperature equal to or less than 400 degrees Celsius, and the catalyst layer is formed so as to cover at least the non-heated area that cannot be heated by the heating element.

Accordingly, the electrically conductive particulates attached to the non-heated area that cannot be heated by the heating element can be oxidized and removed at a temperature equal to or less than 400 degrees Celsius. Thus, use of the particulate sensing element over a long period of time does not raise a problem of depositing the electrically conductive particulates in the non-heated area. Accordingly, the particulate sensing element of high reliability can be realized.

The particulate sensing element according to a third aspect of the embodiment, the catalyst layer is a second catalyst layer made of an electrically insulating catalyst material that can oxidize electrically conductive particulates at a temperature between 400 degrees Celsius and 550 degrees Celsius inclusive.

The catalyst layer is formed so as to cover at least the portions of the upper surface of the electrically insulating heat resistant base plate whose portions are exposed between the pair of sensing electrodes and/or the portions of the upper surface of the electrically insulating heat resistant base plate between the lower surfaces of the sensing electrodes and the upper surface of the electrically insulating heat resistant base plate.

Accordingly, the sensing (measuring) portion is heated by the heating element up to a temperature lower than 400 degrees Celsius, in sensing the concentration of the electrically conductive particulates contained in a gas to be measured, in order to stabilize the temperature characteristics associated with sensing resistance.

In this heating, the second catalyst layer is not activated, and thus the amount of the electrically conductive particulates deposited in the sensing portion can be stably sensed.

On the other hand, at the time of reactivation, the sensing portion is heated by the heating element up to a temperature between 400 degrees Celsius and 550 degrees Celsius inclusive, which temperature is lower than the temperature for starting spontaneous burning.

In this heating, the electrically conductive particulates deposited in the sensing portion can be oxidized and removed in a short time.

Thus, the particulate sensing element can be released from the thermal stress to thereby realize the particulate sensing element of high durability.

A particulate sensor according to a fourth aspect of the embodiment, the particulate sensor installed in a channel for a gas to be measured that senses the concentration of electrically conductive particulates contained in the gas to be measured includes a particulate sensing element that has a sensing portion exposed to the gas to be measured in which a pair of sensing electrodes that face each other formed with a predetermined gap therebetween on a surface of an electrically insulating heat resistant base plate, a heating element that heats the sensing portion to a predetermined temperature, and a catalyst layer that can oxidize the electrically conductive particulates formed at least on a part of a portion except the sensing portion exposed to the gas to be measured.

The particulate sensor further includes a housing that holds a measuring (sensing) portion of the particulate sensing element in gas to be measured, and a cover that protects the sensing portion of the particulate sensing element has inlet and outlet ports to charge/discharge the gas to be measured.

Accordingly, the electrically conductive particulates contained in a gas to be measured introduced into the cover and deposited in an area other than the measuring (sensing) portion of the particulate sensing element are oxidized and removed by the catalyst layer. Thus, a highly reliable particulate sensor can be realized. The particulate sensor according to a fifth aspect of the embodiment, the cover has a partition wall extended inwardly that divides the gas to be measured into the gas to be measured introduced to a non-heated area of the particulate sensing element and the gas to be measured introduced to the sensing portion.

Accordingly, movement of the gas to be measured in contact with the non-heated area can be restricted and the temperature can be suppressed from being lowered. At the same time, entry of the electrically conductive particulates to be in contact with the non-heated area can be blocked.

In this way, deposition of the particulates in the non-heated area can be reduced, while deposited particulates can be readily burnt and removed by the catalyst layer. Thus, durability and reliability of the particulate sensor can be more enhanced,

### BRIEF DESCRIPTION OF THE DRAWINGS

In the accompanying drawings:

FIGS. 1A and 1B are schematic front and side views, respectively, illustrating a particulate sensing element according to a first embodiment;

FIG. 2 is a schematic development view illustrating the particulate sensing element according to the first embodiment;

FIGS. 3A and 3B are schematic front and side views, respectively, illustrating a particulate sensing element according to a second embodiment;

FIGS. 4A and 4B are schematic front and side views, respectively, illustrating a particulate sensing element according to a third embodiment;

FIGS. 5A and 5B are enlarged front and cross-sectional views, respectively, illustrating a principal part of a modification of the particulate sensing element according to the third embodiment;

FIGS. 6A to 6C are characteristic diagrams illustrating the advantageous effects of the embodiment concerning time for completing reactivation, temperature for enabling reactivation, and durability, respectively, in comparison with a comparative example;

FIG. 7 is a schematic cross-sectional view illustrating a particulate sensor having the particulate sensing element according to the first embodiment; and

FIG. 8 is a schematic cross-sectional view illustrating a particulate sensor having the particulate sensing element according to the second embodiment.

### DETAILED DESCRIPTION OF THE PREFERRED EMBODIMENTS

With reference to the accompanying drawings, hereinafter will be described some embodiments.

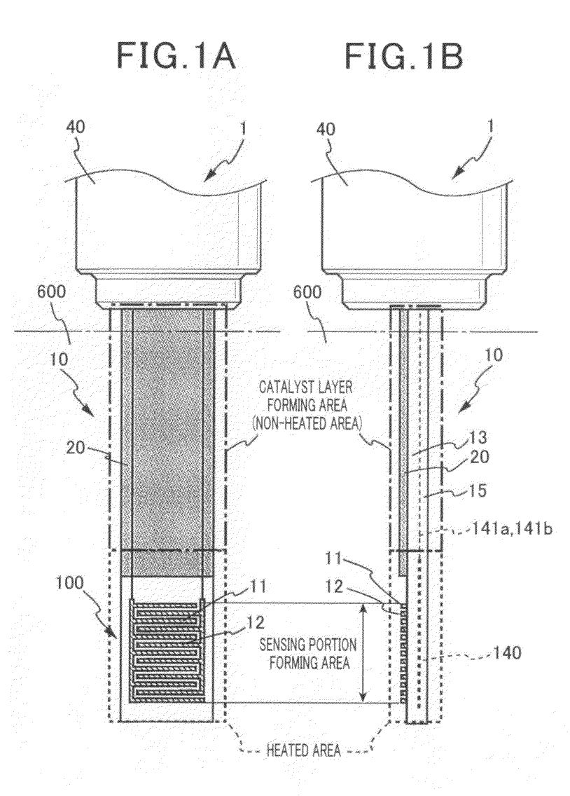

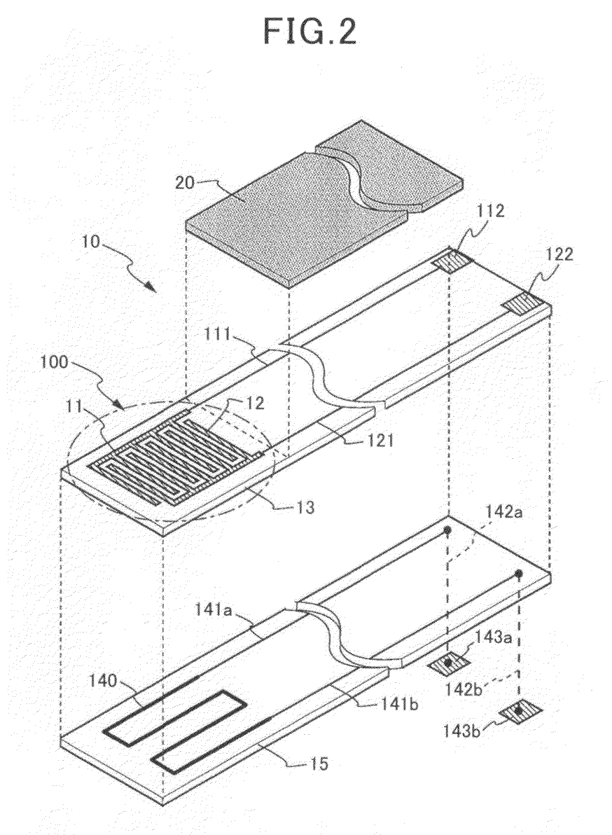

First, referring to FIGS. 1A and 1B and FIG. 2, hereinafter is described a particulate sensing element 10 according to a first embodiment. FIGS. 1A and 1B are schematic front and side views, respectively, illustrating the particulate sensing element 10 according to the first embodiment. FIG. 2 is a schematic development view illustrating the particulate sensing element 10.

For example, the particulate sensing element 10 according to the first embodiment is installed in a diesel engine. In a diesel engine, the particulate sensing element 10 is used for a particulate sensor 1 (the details will be described later) located at an exhaust channel of the diesel engine.

The particulate sensor 1 senses PMs, or electrically conductive particulates, in particular, contained in a gas to be measured, such as an exhaust gas, flowing through the exhaust channel. Through such a sensing activity, the particulate sensor 1 conducts onboard diagnostics (OBD) of a diesel particulate filter (DPF) that captures particulate materials (PMs) contained in the exhaust gas, and conducts reactivation control of the DPF.

As shown in FIGS. 1A and 1B and FIG. 2, the particulate sensing element 10 includes an electrically insulating heat resistant base plate 13 (hereinafter may also be just referred to as “base plate 13”), a pair of sensing electrodes 11, 12, leads 111, 121 and terminals 112, 122, a catalyst layer 20, a heating element 140, a pair of heating element leads 141a, 141b, heating element terminals 143a, 143b, electrically insulating heat resistant base plate 15 (hereinafter may also be just referred to as “base plate 15”), and through-hole electrodes 142a, 142b.

The base plate 13 is provided by forming an electrically insulating heat resistant material, such as alumina, into a plate-like shape using a well-known process, such as doctor blade, press molding, cold isostatic pressing (CIP) or hot isostatic pressing (HIP),

The pair of sensing electrodes 11, 12 are each provided by forming an electrically conductive material, such as platinum, into a comb-like shape using a well-known process, such as screen printing, for location on the base plate 13 with a predetermined distance therebetween.

The leads 111, 121 and the terminals 112, 122 bring the sensing electrodes 11, 12 and externally provided electric resistance measuring means into conduction.

The catalyst layer 20, which is a principal part of the present embodiment, is made of a catalyst material that can oxidize electrically conductive particulates, to cover at least the surface of a non-heated area of the base plate 13.

The heating element 140 heats a sensing (measuring) portion formed by the sensing electrodes 11, 12 up to a predetermined temperature to stabilize sensing resistance, or generates heat with the supply of current to heat and remove PMs deposited in the sensing portion.

The pair of heating element leads 141a, 141b establish connection between the heating element 140 and a current-supply controller, not shown.

The through-hole electrodes 142a, 142b are formed through the base plate 15 to bring the heating element leads 141a, 141b and the heating element terminals 143a, 143b into conduction.

The area in the particulate sensing element 10, which can be heated by the heating element 140 is hereinafter referred to as a “heated area” (the area enclosed by the broken line in the figures), and the area which cannot be heated by the heating element 140 is hereinafter referred to as a “non-heated area” (the area enclosed by the dash-dot line in the figures). This also applies to other embodiments,

The catalyst layer 20, or a first catalyst layer, is made of a catalyst material that can oxidize electrically conductive particulates, such as carbon, contained in a gas to be measured at a temperature equal to or less than 400 degrees Celsius.

The catalyst layer 20 is formed so as to cover at least the non-heated area that cannot be heated by the heating element 140.

Specifically, the catalyst layer 20 may be made, for example, of ceria-based oxides (e.g., Ce_{0.65}Pr_{0.2}La_{0.15}O₂) added with rare earth elements, ceria-zirconia solid solution oxides (e.g., Zr_{0.5}Ce_{0.5}O₂), oxides of Co, Cr, Cu, Fe, V, Mo and Pd as well as alkali metal oxides, Ag-supported oxides (e.g., Ag-supported Al₂O₃ and Ag-supported CeO₂), and metal-supported proton conductor/catalyst (e.g., Pt-supported Sn_{0.9}In_{0.1}P₂O₇).

In order to ensure electrical insulation properties between the catalyst layer 20 and the leads 111, 121, an insulating catalyst material may be used for the catalyst layer 20.

Alternatively, electrically insulating heat resistant protective layers, not shown, may be formed between the catalyst layer 20 and the leads 111, 121 using an electrically insulating heat resistant material to cover the surfaces of the leads 111, 121.

In the case of forming the electrically insulating heat resistant protective layers between the catalyst layer 20 and the leads 111, 121, a noble metal catalyst, such as of Pt, having electrical conductivity may be used as the catalyst 20.

The present embodiment exemplifies the catalyst layer 20 that is formed only on the surface confronting the upstream side of a gas to be measured.

However, the catalyst layer 20 may be formed covering throughout the periphery of the non-heated area of the particulate element 10, including the surface confronting the downstream side of a gas to be measured and both lateral faces. This also applies to other embodiments.

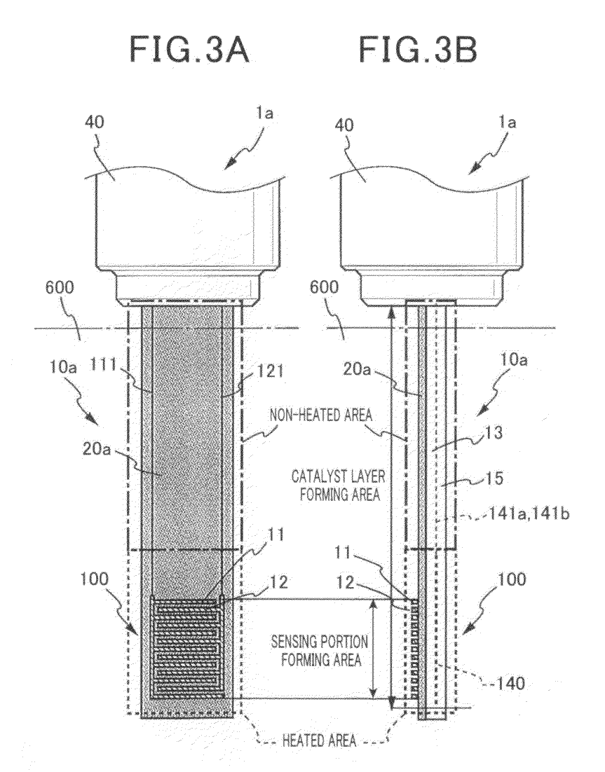

Referring to FIGS. 3A and 3B, hereinafter is described a particulate sensing element 10a according to a second embodiment.

In the second and the subsequent embodiments, the components identical with or similar to those in the first embodiment are given the same reference numerals for the sake of omitting explanation.

In the present embodiment, only the differences from the first embodiment are described. FIGS. 3A and 3B are schematic front and side views, respectively, illustrating a particulate sensing element 10a according to the second embodiment.

In the first embodiment described above, the catalyst layer 20 has been provided at only the non-heated area of the electrically insulating base plate 13,

In the present embodiment, however, a catalyst layer 20a may be extended, as shown in FIGS. 3A and 3B, between the lower surfaces of the sensing electrodes 11, 12 and the upper surface of the base plate 13 to cover the upper surface of the base plate 13.

With this configuration, PMs deposited in a sensing (measuring) portion 100 can be heated and removed at a temperature lower than the spontaneous burning temperature.

In the present embodiment, it is desirable that the catalyst layer 20a may exhibit a catalytic activity at a temperature higher than that for heating the measuring portion 100 during the sensing activity.

In addition, it is required that insulation properties be ensured between the catalyst layer 20a and the sensing electrodes 11, 12.

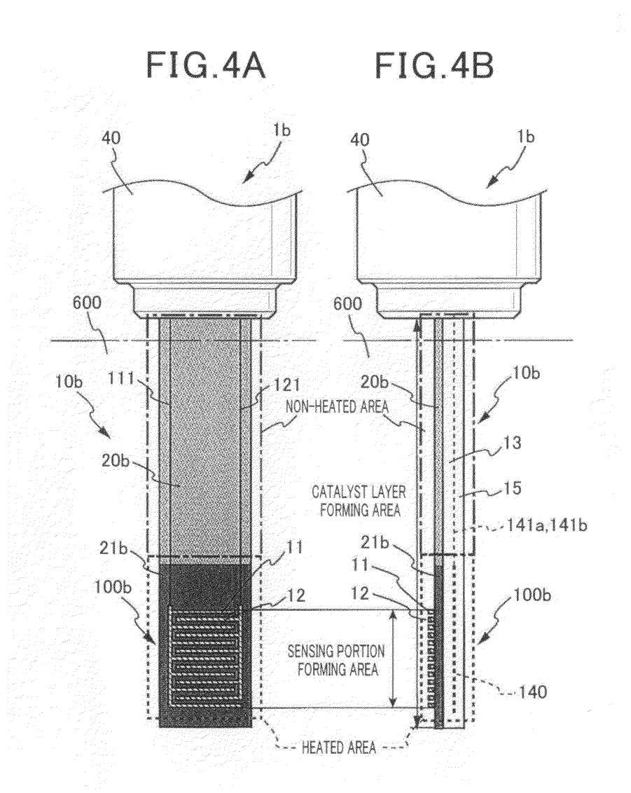

Referring to FIGS. 4A and 4B, hereinafter is described a particulate sensing element 10b according to a third embodiment. FIGS. 4A and 4B are schematic front and side views, respectively, illustrating a particulate sensing element 10b according to the third embodiment.

In the present embodiment, as shown in FIGS. 4A and 4B, a first catalytic layer 20b similar to the catalytic layer 20 of the first embodiment is provided at the non-heated area that cannot be heated by the heating element 140, while a second catalyst layer 21b is provided at the heated area (the area where the sensing portion is formed) that can be heated by the heating element 140.

The second catalyst layer 21b is made of an electrically insulating catalyst material that is able to oxidize electrically conductive particulates at a temperature between 400 degrees Celsius and 550 degrees Celsius inclusive.

When the concentration of electrically conductive particulates contained in a gas to be measured is sensed at a sensing (measuring) portion 100b with this configuration, the second catalyst layer 21b will not be activated because the sensing portion 100b is heated by the heating element 140 only up to a temperature lower than 400 degrees Celsius in order to stabilize the temperature characteristics associated with sensing resistance.

Thus, the amount of the electrically conductive particulates deposited in the sensing portion 100b can be sensed in a stable manner.

On the other hand, when the sensing portion 100b is heated by the heating element 140 up to a temperature between 400 degrees Celsius and 550 degrees Celsius inclusive at the time of reactivation, which temperature is lower than the temperature of starting spontaneous burning, the particulates deposited in the sensing portion 100b can be oxidized and removed in a short time.

It is desirable that the first catalyst layer 20b formed in the non-heated area is a catalyst layer that exhibits catalytic activity at a temperature lower than 400 degrees Celsius.

In this way, owing to the use of the first catalyst layer 20b and the second catalyst layer 21b having different activation temperature, PMs deposited in the measuring portion 100b will not be removed by heating during the sensing activity but only the PMs deposited in the non-heated area can be oxidized and removed without requiring additional heating.

Meanwhile, during reactivation of the particulate sensing element, PMs can be oxidized and removed in a prompt manner by being heated by the heating element 140 up to a temperature between 400 degrees Celsius and 550 degrees Celsius inclusive, thereby enhancing durability and reliability as a sensor.

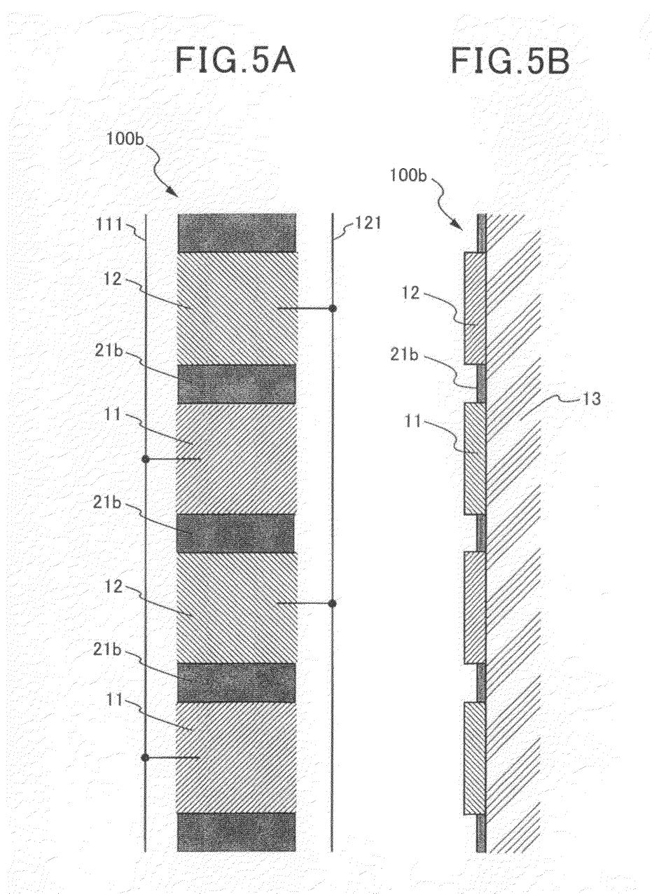

FIGS. 5A and 5B are enlarged front and cross-sectional views, respectively, illustrating a principal part of a modification of the particulate sensing element 10b according to the third embodiment.

In the third embodiment described above, the second catalyst layer 21b has been provided between the lower surfaces of the sensing electrodes 11, 12 and the upper surface of the base plate 13, i.e, has been provided to cover the entire upper surface of the base plate 13 in the sensing portion 100b.

However, as shown in FIGS. 5A and 5B, the catalyst layer 21b may be formed so as to cover only the portions of the upper surface of the base plate 13, which portions are exposed between the pair of sensing electrodes 11, 12.

With this configuration as well, the advantageous effects similar to those in the above embodiments can be obtained. In addition, the amount of use of an expensive catalyst can be reduced owing to this configuration, because the second catalyst layer 21b is formed only at the portions of the upper surface of the sensing portion 100b of the base plate 13, which portions are exposed between the sending electrodes 11, 12.

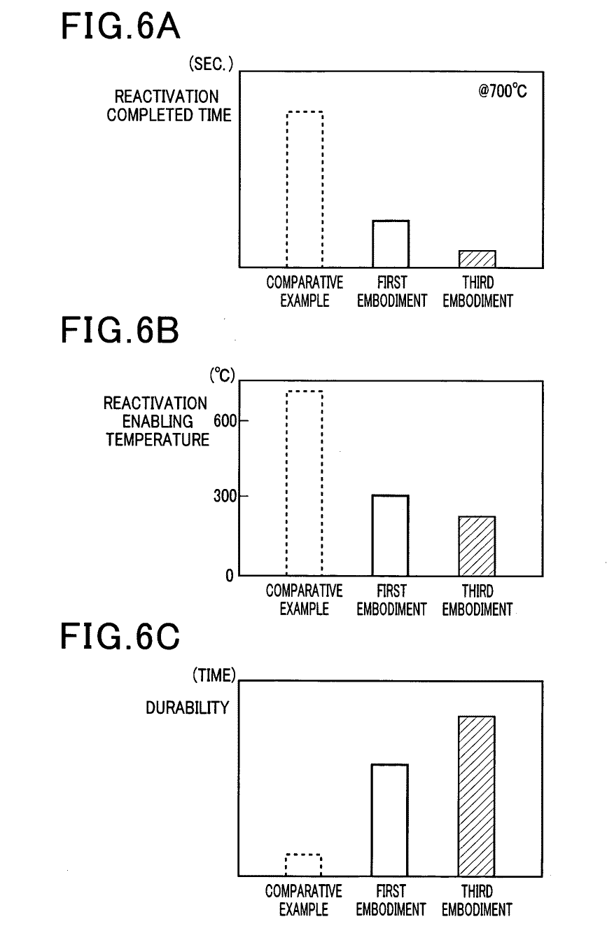

Referring now to FIGS. 6A to 6C, the advantageous effects of the present embodiment will be described. The inventors of the present embodiment conducted a comparison experiment using the particulate sensing element 10 of the first embodiment shown in FIGS. 1A and 1B, the particulate sensing element 10b of the third embodiment shown in FIGS. 4A and 4B, and a particulate sensing element, as a comparative example, provided with neither the first catalyst layer 20 (20a) nor the second catalyst layer 21b.

The experiment was conducted by passing current to the heating element 140 from when PMs were deposited and the electrical resistance sensed between the sensing elements 11, 12 was stabilized.

The experiment was conducted concerning: time taken for the particulate sensing element to be completely reactivated including the time for the sensing electrodes 11, 12 to be electrically insulated from one another, as shown in FIG. 6A; temperature that enables reactivation, as shown in FIG. 6B; and durability, as shown in FIG. 6C.

The results of the experiment on the first embodiment, the second embodiment and the comparative example are shown in FIGS. 6A to 6C.

As shown in FIGS. 6A to 6C, it has been found that the present embodiment can shorten the time taken for completing reactivation, reduce the temperature that enables reactivation and lengthen the durable life time of the particulate sensing element.

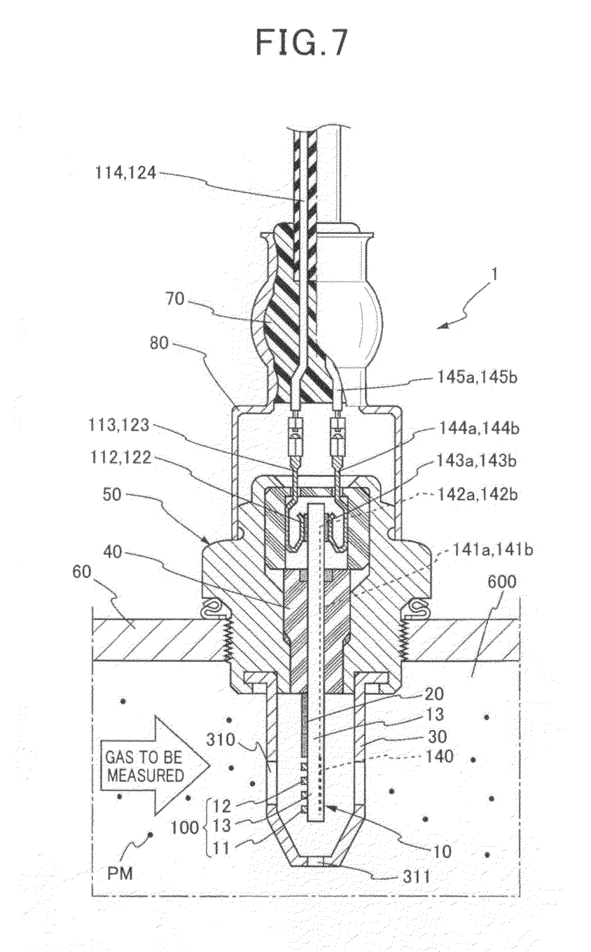

Referring to FIG. 7, hereinafter is described the particulate sensor 1 having the particulate sensing element 10 of the first embodiment described above, which is partially provided with the catalyst layer 20 at a portion exposed to a gas to be measured.

Instead of the particulate sensing element 10, the particulate sensing element 10a of the second embodiment or the particulate sensing element 10b of the third embodiment may be used.

The particulate sensor 1 is configured by an insulator 40, a housing 50, a cover 30, a pair of signal lines 114, 124 and a casing 80.

The insulator 40 has a substantially cylindrical shape, in the inside of which the particulate sensing element 10 is inserted and held.

The housing 50 is secured to a channel wall 60 of a channel 600 for a gas to be measured and holds the insulator 40, while holding the sensing portion 100 of the particulate sensing element 10 at a predetermined position in the channel 600.

The cover 30 is provided on a tip end side of the housing 50 to protect the sensing portion 100 of the particulate sensing element 10. The pair of signal lines 114, 124 are provided on a base end side of the housing 50 and connected to the terminals 112, 122 of the particulate sensing element 10 via joints 113, 123, respectively.

The signal lines 114, 124 transmit sensed electrical resistance Rx between the sensing electrodes 11, 12 to externally provided electrical resistance sensing means. The electrical resistance Rx changes according to the amount of PMs captured and deposited in the sensing portion 100.

The casing 80 has a substantially cylindrical shape and fixes, on the base end side, a pair of conducting lines 145a, 145b via a sealing member 70. The conducting lines 145a, 145b are connected to the heating element 140 incorporated in the particulate sensing element 10, via the heating element terminals 143a, 143b and joints 144a, 144b, respectively.

The cover 30 is punched with inlet and outlet ports 310, 311 to charge/discharge a gas to be measured containing PMs into/from the cover 30, for the sensing portion 100.

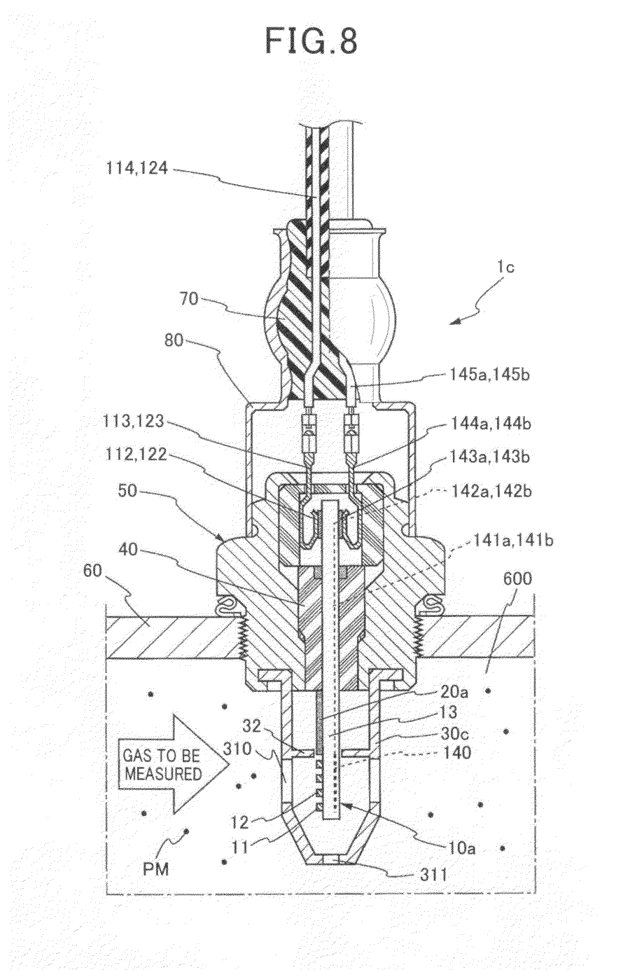

Referring to FIG. 8, hereinafter is described a particulate sensor 1c having the particulate sensing element 10a of the second embodiment.

As can be seen from FIG. 8, the particulate sensing element 10a is provided with a cover 30c in which a substantially annularly shaped partition wall 32 is formed in the inner side surface, being radially extended inward.

The partition wall 32 divides a gas to be measured into the gas to be measured which is introduced to and in contact with the heated area that can be heated by the heating element 140 of the particulate sensing element 10a, and the gas to be measured which is introduced to and in contact with the non-heated area that cannot be heated by the heating element 140.

With this configuration of the cover 30c, the movement of the gas to be measured in contact with the non-heated area can be restricted and the temperature can be suppressed from being lowered. At the same time, entry of the PMs to be in contact with the non-heated area can be blocked.

In this way, deposition of PMs in the non-heated area can be reduced, while deposited PMs can be readily oxidized and removed by the catalyst layer 20a covering the non-heated area.

The present embodiment is not limited to the embodiments described above but may be modified as appropriate within a range not departing from the spirit of the present embodiment.

For example, in the above embodiments, the sensing electrodes 11, 12 each have had a comb-like shape extended in the direction perpendicular to the longitudinal direction of the particulate sensing element 10 and been permitted to face one another to thereby provide a pair of electrodes.

However, the shape of the pair of sensing electrodes 11, 12 is not particularly limited in the present embodiment. The sensing electrodes 11, 12 may each have a comb-like shape extended in the longitudinal direction of the particulate sensing element 10 to provide a pair of electrodes facing one another with a predetermined distance therebetween.

Alternatively, the sensing electrodes 11, 12 may each have a substantially spiral shape to provide a pair of electrodes with a predetermined distance therebetween. Alternatively, the sensing electrodes 11, 12 may be permitted to face one another in parallel to provide a pair of electrodes with a predetermined distance therebetween.

Further, the particulate sensor in each of the embodiments described above has been installed in an internal combustion engine such as of a motor vehicle.

However, the particulate sensor of the present embodiment is not limited to the use in vehicles but may be available for particulate detection in a large-scale plant, such as a thermal electric power plant.

What is claimed is:

1. A particulate sensing element that detects a concentration of electrically conductive particulates in a gas to be measured comprising:
a sensing portion exposed to the gas to be measured in which a pair of sensing electrodes that face each other formed with a predetermined gap therebetween on a surface of an electrically insulating heat resistant base plate, and
a heating element that heats the sensing portion to a predetermined temperature, wherein
a catalyst layer that can oxidize the electrically conductive particulates is formed at least on a part of a portion except the sensing portion exposed to the gas to be measured.

2. The particulate sensing element according to claim 1, wherein,
the catalyst layer is a first catalyst layer made of a catalyst material that can oxidize electrically conductive particulates at a temperature equal to or less than 400 degrees Celsius, and
the catalyst layer is formed so as to cover at least the non-heated area that cannot be heated by the heating element.

3. The particulate sensing element according to claim 1, wherein,
the catalyst layer is a second catalyst layer made of an electrically insulating catalyst material that can oxidize electrically conductive particulates at a temperature between 400 degrees Celsius and 550 degrees Celsius inclusive,
the catalyst layer is formed so as to cover at least the portions of the upper surface of the electrically insulating heat resistant base plate whose portions are exposed between the pair of sensing electrodes and the portions of the upper surface of the electrically insulating heat resistant base plate between the lower surfaces of the sensing electrodes and the upper surface of the electrically insulating heat resistant base plate.

4. The particulate sensing element according to claim 2, wherein,
the catalyst layer is a second catalyst layer made of an electrically insulating catalyst material that can oxidize electrically conductive particulates at a temperature between 400 degrees Celsius and 550 degrees Celsius inclusive,
the catalyst layer is formed so as to cover at least the portions of the upper surface of the electrically insulating heat resistant base plate whose portions are exposed between the pair of sensing electrodes and the portions of the upper surface of the electrically insulating heat resistant base plate between the lower surfaces of the sensing electrodes and the upper surface of the electrically insulating heat resistant base plate.

5. The particulate sensing element according to claim 1, wherein,
the catalyst layer is a second catalyst layer made of an electrically insulating catalyst material that can oxidize electrically conductive particulates at a temperature between 400 degrees Celsius and 550 degrees Celsius inclusive,
the catalyst layer is formed so as to cover at least the portions of the upper surface of the electrically insulating heat resistant base plate whose portions are exposed between the pair of sensing electrodes or the portions of the upper surface of the electrically insulating heat resistant base plate between the lower surfaces of the sensing electrodes and the upper surface of the electrically insulating heat resistant base plate.

6. The particulate sensing element according to claim 2, wherein,
the catalyst layer is a second catalyst layer made of an electrically insulating catalyst material that can oxidize electrically conductive particulates at a temperature between 400 degrees Celsius and 550 degrees Celsius inclusive,
the catalyst layer is formed so as to cover at least the portions of the upper surface of the electrically insulating heat resistant base plate whose portions are exposed between the pair of sensing electrodes or the portions of the upper surface of the electrically insulating heat resistant base plate between the lower surfaces of the sensing electrodes and the upper surface of the electrically insulating heat resistant base plate.

7. A particulate sensor installed in a channel for a gas to be measured that senses the concentration of electrically conductive particulates contained in the gas to be measured comprising:
a particulate sensing element having:
a sensing portion exposed to the gas to be measured in which a pair of sensing electrodes that face each other formed with a predetermined gap therebetween on a surface of an electrically insulating heat resistant base plate,
a heating element that heats the sensing portion to a predetermined temperature,
a catalyst layer that can oxidize the electrically conductive particulates formed at least on a part of the sensing portion exposed to the gas to be measured,
a housing that holds a measuring (sensing) portion of the particulate sensing element in gas to be measured, and
a cover that protects the sensing portion of the particulate sensing element has inlet and outlet ports to charge/discharge the gas to be measured.

8. The particulate sensor according to claim 7, wherein,
the catalyst layer is a first catalyst layer made of a catalyst material that can oxidize electrically conductive particulates at a temperature equal to or less than 400 degrees Celsius, and
the catalyst layer is formed so as to cover at least the non-heated area that cannot be heated by the heating element.

9. The particulate sensor according to claim 7, wherein,
the catalyst layer is a second catalyst layer made of an electrically insulating catalyst material that can oxidize electrically conductive particulates at a temperature between 400 degrees Celsius and 550 degrees Celsius inclusive,
the catalyst layer is formed so as to cover at least the portions of the upper surface of the electrically insulating heat resistant base plate whose portions are exposed between the pair of sensing electrodes and the portions of the upper surface of the electrically insulating heat resistant base plate between the lower surfaces of the sensing electrodes and the upper surface of the electrically insulating heat resistant base plate.

10. The particulate sensor according to claim 7, wherein,
the catalyst layer is a second catalyst layer made of an electrically insulating catalyst material that can oxidize electrically conductive particulates at a temperature between 400 degrees Celsius and 550 degrees Celsius inclusive,
the catalyst layer is formed so as to cover at least the portions of the upper surface of the electrically insulating heat resistant base plate whose portions are exposed between the pair of sensing electrodes or the portions of the upper surface of the electrically insulating heat resistant base plate between the lower surfaces of the sensing electrodes and the upper surface of the electrically insulating heat resistant base plate.

11. The particulate sensor according to claim 7, wherein,
the cover has a partition wall extended inwardly that divides the gas to be measured into the gas to be measured introduced to a non-heated area of the particulate sensing element and the gas to be measured introduced to the sensing portion.
